(19) United States
(12) Patent Application Publication
(10) Pub. No.: US 2007/0042808 A1
(43) Pub. Date: Feb. 22, 2007

(54) Operating system for a mobile phone

(75) Inventor: Jari Ruuttu, Billnas (FI)

Correspondence Address: YOUNG & THOMPSON, 745 SOUTH 23RD STREET, 2ND FLOOR, ARLINGTON, VA, 22202, US

(73) Assignee: FORTION DESIGNIT OY, Espoo (FI)

(21) Appl. No.: 10/555,547

(22) PCT Filed: May 4, 2004
(86) PCT No.: PCT/FI04/00267

§ 371 Date: Jul. 25, 2006

(30) Foreign Application Priority Data
May 5, 2003 (FI) 20030672

(51) Int. Cl. H04M 1/00

(52) U.S. Cl. 455/558

(57) ABSTRACT

An operating system for a mobile phone (1) includes a mobile phone having storage capacity adapted to the operating system, such as RAM, ROM, PROM or E-PROM, and a user identifier card provided by the operator, such as a SIM card (8). The data carried by the user identifier card supplied by the operator can be fed into the storage space of the mobile phone (1) from outside the mobile phone, with the user identifiers (20-23) of more than one operator being fed to the same mobile phone.

This invention relates to an operating system for a mobile phone, the operating system comprising a mobile phone having storage capacity adapted to the operating system, such as a RAM, ROM, PROM or E-PROM, and a user identifier card, such as a SIM, issued by the operator.

The new invention proposes a solution in which the currently used replaceable SIM card in a mobile phone, for instance, is replaced in the manner of the invention, the solution being characterised by the SIM card data being transferred to e.g. an E-PROM provided in the device itself a) via contact surfaces at the bottom of the device, b) via IR Blue Tooth or c) by radiowaves.

The objective of the invention is to replace the current practice, involving insertion of the teleoperator's SIM card into the device in a physical form.

There are many very cogent reasons for such replacement: firstly, insertion of the physical SIM card into the device itself makes the user dependent on one single operator. The user will not be able to have different teleoperators compete in real time.

Secondly, the insertion of a physical SIM card causes problems, as it may occupy up to 25% of the circuit board area, preventing a flatter and smaller-sized design of the device. This will consequently have a pervasive impact on the design and physical size of the device, and also on the construction itself.

Thirdly, if a watertight device is desired, for the reasons above, the replaceable physical SIM card will prevent a reasonable construction that would expressly provide a waterproof mobile phone.

Fourthly, absence of one or more SIM cards from the mobile phone yields better operating safety.

References disclosing solutions known per se can be cited as prior art.

DE patent specification 10023407 sets forth a solution relating specifically to SIM cards or similar storage units, which are replaceable in the mobile phone or device.

DE patent specification 10004164 discloses a solution that does not relate to replaceable SIM cards or similar information. The data are stored in electronic form in the mobile phone via an existing GSM or UMTS system network.

This invention is based on a solution, in which the teleoperator's SIM card is no longer inserted in physical form into the mobile phone, but the data carried by the SIM card are transferred e.g. to an E-PROM of the mobile phone, a) via data contact surfaces at the bottom of the device, b) by IR-Blue Tooth or c) by radiowaves.

The invention does not propose elimination of SIM cards, but the fact that the SIM card is no longer placed in the device itself, for the reasons given above.

The aim is not to eliminate the SIM card, which the teleoperator hands to the customer who is making a subscription, because the card comprises functions controlling the mobile phones of different teleoperators, these functions being operator-specific, such as billing, operating system, various functions, such as services, etc.

Consequently, this invention does not alter or eliminate the teleoperator's function, by contrast, it gives the customer full freedom of choice between different operators in real time. This means that the customer may have the teleoperators compete in a manner that would be impossible, had the customer to replace the SIM card each time he wishes to shift to a new operator.

The invention will have even greater impact at the time of adopting the new practice of maintaining the phone number even though the teleoperator changes.

This invention will also substantially affect the physical construction of the mobile phone proper, because it may be given a technically flatter design, ˜3-6 mm, and because the surface requirement of the SIM card is up to 25% of the circuit board of the phone, a smaller size will also be achieved.

This is of great relevance, considering that most of currently manufactured mobile phones have their electronic and electric components located on one side only of the circuit board, and with a phone comprising one single circuit board, 25% of the board will be available for other purposes of utilisation than that of a SIM card holder.

This has an extremely great impact on the design, because the mobile phone can be designed on quite a different basis, in other words, if desired, a markedly flatter and also substantially smaller-sized mobile phone can be achieved.

Technically speaking, the phone can now be manufactured with a totally waterproof construction, with the circuit board completely encapsulated, and this is allowed by the fact that the circuit board does not have to be touched since it no longer carries the SIM card in a physical form.

The invention will be described by means of drawings in the following.

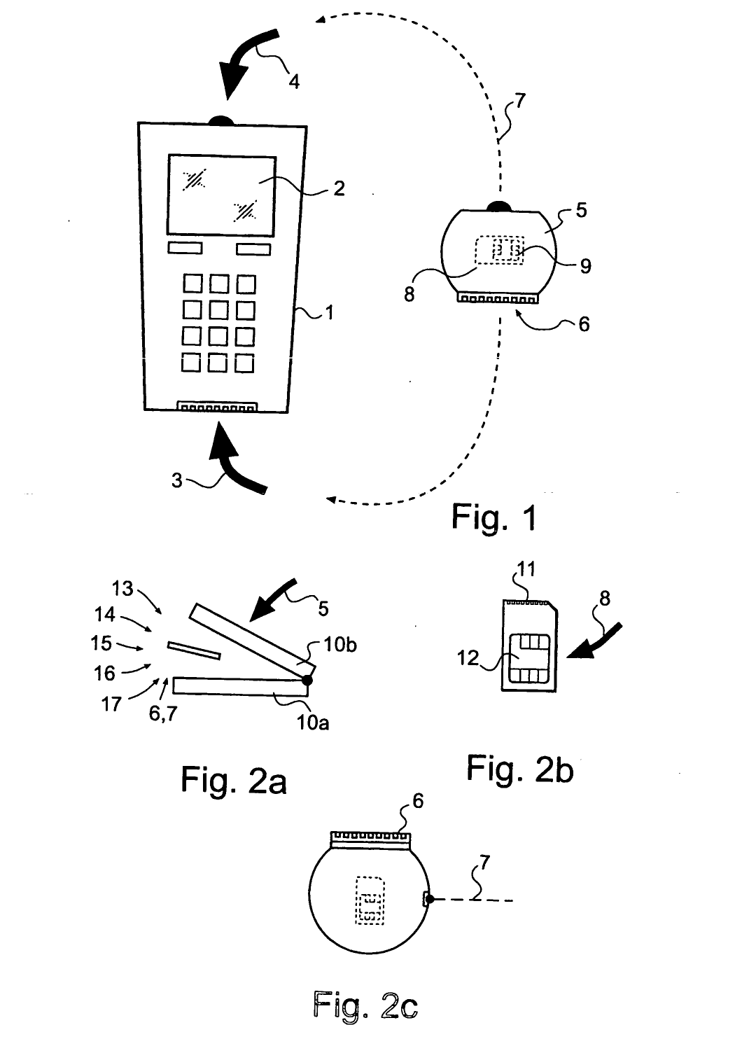

FIG. 1 shows a mobile phone 1, which is a standard model in all other respects, except that it has no SIM card and thus no SIM card reader/holder located within the mobile phone proper.

The mobile phone 1 comprises one or more “buses”, over which an external SIM card 8 can transfer data to the mobile phone 1 via data contact surfaces 3 at the bottom of the device 1, this transfer requiring physical contact between the SIM card and the contact surfaces of the mobile phone.

If the SIM card 8 is located in a specifically manufactures SIM card “holder” 5, it may comprise an IR Blue Tooth transmitter unit 7. This allows the user to communicate with the mobile phone 1 over a transceiver of the IR Blue Tooth 4 provided in this.

A third option consists in communication between the mobile phone 1 and the SIM card holder (module) over radiowaves, a feature that is known e.g. from locking installations of cars and residential buildings.

FIG. 2 illustrates a different SIM card “holder” 5, which comprises a) a shaped contact surface 6, which tallies with data contact surfaces 3 provided at the bottom of the mobile phone 1, and an IR Blue Tooth transceiver 7. This example allows a user to use either of the buses or only one of them.

The SIM card holder/reader unit 5 can be shaped so as to be openable, for instance, i.e. comprising a bottom member 10 A and a cover member 10 B, and when the cover 11 is opened, the SIM card 8 can be withdrawn or replaced with another one.

The SIM card holder/reader 5 may have space for more than one SIM card 8 at the same time, e.g. 1 user i.e. number data SIM card 13 and an image/video card 16.

There has also been provision for the SIM card holder/reader 5 to have an individual power source, e.g. a battery, which is a condition if the SIM card holder/reader operates without any physical contact, such as the IR-Blue Tooth operation described above. It may also comprise a press keyboard, which is intended for OFF/ON, SEND functions and the like.

In the preferred case, the will be no need for a separate SIM card reader/holder at all, but the actual SIM card 8 is shaped so as to match the contact surfaces of the mobile phone.

Given the purpose of utilising the data transfer contact surfaces 3 of the mobile phone 1 shown in FIG. 1, which are standard contact surfaces in all mobile phones, the current SIM card concept needs to be altered by shifting the contact surfaces of the SIM card 8 to its outer edge 11.

In a potentially advantageous embodiment, an injection-moulded frame member, which smoothly fits the mobile phone of this particular manufacturer, is connected to the SIM card (of the invention).

Application

The customer uses the method of the invention in exactly the same manner as he proceeds with the currently used SIM card, except that he no longer inserts the SIM card into the device itself, but sends the SIM card data to the mobile phone as described above.

This will allow the customer to load down the subscription of more than one operator in his mobile phone.

The practice may be as follows (FIG. 2 8).

The customer places the SIM card in the SIM card “holder/reader” 5 and locks the cover 10 B. Next he affixes the SIM card reader/transmitter holder to the data contact surface 3 of the mobile phone 1, as shown in FIG. 1, and performs the same operations as before, e.g. gives the PIN code. In the exemplified case, the device reports when the operation has been carried out.

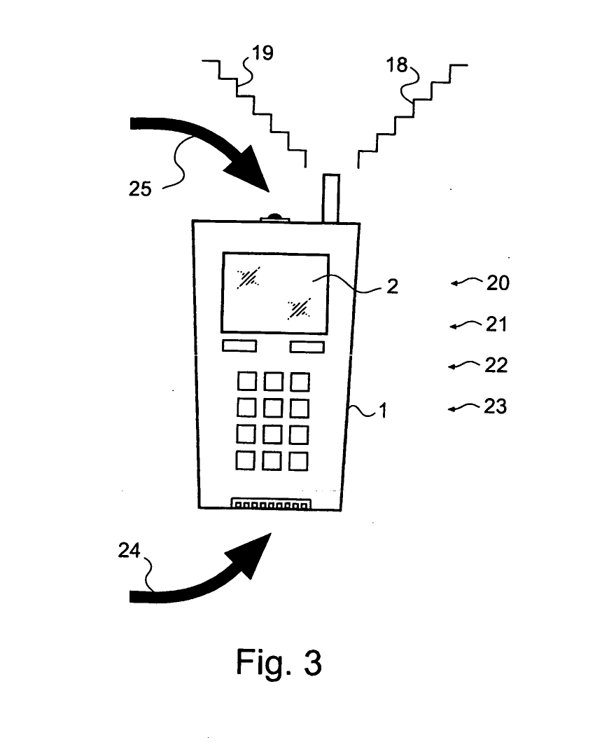

FIG. 3

When the subscriptions of several operators have been fed into the mobile phone, the mobile phone can receive an incoming call 19 having the same operator subscription as the caller.

The mobile phone user may ask all the operators whose subscriptions are connected to the mobile phone for a talk time offer in real time, for instance while being abroad, where talk time is relatively expensive. This will make the operators compete and lead to dropping call prices.

Talk time 22,23 can also be loaded in a mobile phone. The user of the mobile phone can feed subscriptions of e.g. Radiolinja 20, Sonera 21, DNA 22 or even three different numbers 23 of Radiolinja.

1. An operating system for a mobile phone (1), the operating system comprising a mobile phone having storage capacity adapted to the operating system, such as a RAM, ROM, PROM or E-PROM, and the user identifier card provided by the operator, such as a SIM (8), characterised in that the data carried by the user identifier card supplied by the operator can be fed into the storage space of the mobile phone (1) from outside the mobile phone, with the user identifiers (20-23) of more than one operator fed to the same mobile phone.

2. Operating system as defined in claim 1, characterised in that the data of the user identifier card can be fed into the storage space of the mobile phone via mechanical contact surfaces (6).

3. Operating system as defined in claim 1, characterised in that the data of the user identifier card can be fed into the storage space of the mobile phone by means of an “IR Blue Tooth” transmitter (7).

4. Operating system as defined in claim 1, characterised in that the data of the user identifier card can be fed into the storage space of the mobile phone by means of radio frequency waves.

5. Operating system as defined in claim 1, characterised in that a specific protective housing (5) has been provided for the user identifier card, the housing having contact surfaces (6) for feeding data to the mobile phone.

6. Operating system as defined in claim 1, characterised in that a specific protective housing (5) has been provided for the user identifier card, the housing having an “IR Blue Tooth” transmitter (7) for transmitting data to the mobile phone.

7. Operating system as defined in claim 1, characterised in that a specific protective housing has been provided for the user identifier card, the housing having a radio transmitter for transmitting data to the mobile phone.

8. Operating system as defined in claim 2, characterised in that a specific protective housing (5) has been provided for the user identifier card, the housing having an “IR Blue Tooth” transmitter (7) for transmitting data to the mobile phone.

9. Operating system as defined in claim 3, characterised in that a specific protective housing (5) has been provided for the user identifier card, the housing having an “IR Blue Tooth” transmitter (7) for transmitting data to the mobile phone.

10. Operating system as defined in claim 4, characterised in that a specific protective housing (5) has been provided for the user identifier card, the housing having an “IR Blue Tooth” transmitter (7) for transmitting data to the mobile phone.

11. Operating system as defined in claim 2, characterised in that a specific protective housing has been provided for the user identifier card, the housing having a radio transmitter for transmitting data to the mobile phone.

12. Operating system as defined in claim 3, characterised in that a specific protective housing has been provided for the user identifier card, the housing having a radio transmitter for transmitting data to the mobile phone.

13. Operating system as defined in claim 4, characterised in that a specific protective housing has been provided for the user identifier card, the housing having a radio transmitter for transmitting data to the mobile phone.
